(19) United States
(12) Patent Application Publication
(10) Pub. No.: US 2011/0059274 A1
(43) Pub. Date: Mar. 10, 2011

(54) METHOD OF PRODUCING RECORDING MEDIUM AND INKJET RECORDING MEDIUM

(75) Inventor: Ryoichi NAKANO, Kanagawa (JP)

(73) Assignee: FUJIFILM CORPORATION, Tokyo (JP)

(21) Appl. No.: 12/874,234

(22) Filed: Sep. 2, 2010

(30) Foreign Application Priority Data
Sep. 10, 2009 (JP) 2009-209817

(51) Int. Cl. B41M 5/40; B32B 38/10; B32B 3/02

(52) U.S. Cl. 428/32.34; 156/247; 428/336

(57) ABSTRACT

The invention provides a method of producing a recording medium, the method having: providing a support, the support having: a resin layer having a polyolefin resin and provided on one side or both sides of a base paper; and a latex-containing layer formed by applying at least a latex on the resin layer; subjecting a latex-containing layer-side surface of the support to a cooling-separation treatment using a cooling-separation belt-fixing smoother apparatus, the apparatus having a heating and pressurizing unit, the unit having a belt member, and the cooling-separation treatment having separating the latex-containing layer-side surface of the support from the belt member; and forming an image recording layer on the latex-containing layer-side surface of the support which has been subjected to the cooling-separation treatment.

### CROSS-REFERENCE TO RELATED APPLICATION

This application claims priority under 35 USC 119 from Japanese Patent Application No. 2009-209817 filed on Sep. 10, 2009, the disclosure of which is incorporated by reference herein.

### BACKGROUND

1. Field of the Invention

The present invention relates to a method of producing a recording medium. The present invention further relates to an inkjet recording medium.

2. Related Art

Many proposals have been made regarding the application of heat and pressure treatment to recording media including a thermoplastic resin so as to improve smoothness and glossiness of the surface of printed matter.

For example, (1) an image forming method in which an image is formed on a recording medium having a porous surface layer containing a thermoplastic resin and then pressure is applied while heating to make the surface smooth (see, for example, Japanese Patent No. 3703325), (2) a recording method in which recording is performed by applying ink droplets onto a recording medium having a laminate material layer for forming a laminate layer and then a laminate layer is formed by applying heat and pressure (see, for example, Japanese Patent No. 2908518), and (3) a manufacturing method in which a recording medium having a resin layer containing a polyolefin resin is subjected to a smoothing treatment by applying heat and pressure using a belt fixing smoother apparatus utilizing a cooling-separation system (see, for example, Japanese Patent Application Laid-Open (JP-A) Nos. 2005-153263 and 2004-114447) have been described.

### SUMMARY

The methods described in Japanese Patent Nos. 3703325 and 2908518 are methods utilizing a processing system in which processing is performed after a recording image has been formed on a recording medium. Therefore, a device for applying heat and pressure needs be provided in the recording device or as a subsequent device. This means that it is necessary to provide a considerable amount of additional machinery, as a result of which the method have a limited range of application.

The methods described in JP-A Nos. 2005-153263 and 2004-114447 are methods which subject an image forming material, an image fixing material or a recording medium to cooling-separation treatment after forming an image recording layer or an ink receiving layer of the image forming material. Since the cooling-separation treatment sometimes impairs the performance of the image receiving layer, the smoothing treatment should be performed under conditions that cause less deterioration in performance.

One aspect of the present invention is a method of producing a recording medium, the method comprising: providing a support, the support comprising: a resin layer comprising a polyolefin resin and provided on one side or both sides of a base paper; and a latex-containing layer formed by applying at least a latex on the resin layer; subjecting a latex-containing layer-side surface of the support to a cooling-separation treatment using a cooling-separation belt-fixing smoother apparatus, the apparatus comprising a heating and pressurizing unit, the unit comprising a belt member, and the cooling-separation treatment comprising separating the latex-containing layer-side surface of the support from the belt member; and forming an image recording layer on the latex-containing layer-side surface of the support which has been subjected to the cooling-separation treatment.

Another aspect of the present invention is a recording medium produced by the method of producing a recording medium, wherein the recording medium is an inkjet recording medium.

Still another aspect of the present invention is an inkjet recording medium produced by the method of producing a recording medium, wherein the resin layer containing a polyolefin resin has a thickness of from 10 μm to 18 μm, and a surface roughness SRa of from 0.02 μm to 0.20 μm with a frequency of from 0.2 mm to 0.3 mm.

### BRIEF DESCRIPTION OF THE DRAWING

FIG. 1 is a schematic diagram showing an example of a cooling-separation treatment using a cooling-separation-belt-fixing smoother apparatus for the method of producing a recording medium of one embodiment.

### DETAILED DESCRIPTION

One exemplary embodiment of the invention is a method of producing a recording medium, the method including at least: providing a support, the support having at least: a resin layer comprising a polyolefin resin and provided on one side or both sides of a base paper; and a latex-containing layer formed by applying at least a latex on the resin layer; subjecting a latex-containing layer-side surface of the support to a cooling-separation treatment using a cooling-separation belt-fixing smoother apparatus, the apparatus having at least a heating and pressurizing unit, the unit having at least a belt member, and the cooling-separation treatment including at least separating the latex-containing layer-side surface of the support from the belt member; and forming an image recording layer on the latex-containing layer-side surface of the support which has been subjected to the cooling-separation treatment.

Specifically, in embodiments, the method is directed to producing a recording medium in which a support, which has a resin layer (hereinafter, referred to as a “polyolefin resin layer” in some cases) containing a polyolefin resin (preferably as a main component) and a layer formed by applying a latex on the resin layer, is subjected to cooling-separation treatment using a cooling-separation system belt fixing type smoothing apparatus so as to smoothen the polyolefin resin layer and an undercoat layer provided on the support, and then an image recording layer is formed on the support, whereby a recording medium having excellent image clarity and reduced surface defects may be provided.

Here, the term “main component” refers to a component contained at a ratio of 60% by mass or higher with respect to the total solid content of the polyolefin resin layer.

The “solid” of one layer or a liquid which is applied to form the layer herein means a component of the layer or the liquid which remains when the liquid is applied over the support is dried (namely, when a solvent of the liquid is removed) to form the layer.

There is no particular limitation on actual embodiments and uses of the recording medium. The recording medium may suitably be used for various applications in which recording media having a paper support are used, and which require one or more characteristics of water resistance, surface smoothness, glossiness, and image clarity. Specifically, the recording medium may be used as an inkjet recording medium, a printing paper, a silver-salt photographic paper, a thermal color-forming material, a sublimation transfer image-receiving material, or the like.

With respect to the image clarity of the recording medium, the measured value of the image clarity of the image recording layer-side of the recording medium may be preferably 70% or more, and more preferably 80% or more, when measured in accordance with the image clarity test method defined in Japanese Industrial Standards (JIS) H8686-2: 1999, the disclosure of which is incorporated herein by reference, under the following measurement conditions.

Measurement mode: reflection; measurement angle: 60′; and optical comb: 2.0 mm. JIS H8686-2: 1999 substantially corresponds to ISO 10216:1992.

Support

The support according this embodiment includes a base paper, a polyolefin resin layer formed over (on or above) one side or both sides of the base paper, and an undercoat layer which contains a latex and is formed over the polyolefin resin layer.

Since this support includes the polyolefin resin layer and the undercoat layer formed over the polyolefin resin layer, when the support is subjected to a cooling-separation treatment using a cooling-separation belt-fixing smoother apparatus, the support, in particular, the polyolefin resin layer and the undercoat layer included therein, are smoothened, and, therefore, the recording medium having an image forming layer formed over this undercoat layer may exhibit excellent image clarity and reduced surface defects.

In embodiments, the support preferably may include a layer containing a pigment over one side of the base paper. When the support includes the layer containing a pigment over one side of the base paper, the image recording layer is preferably formed over the other side, i.e., the side of the support not having the pigment-containing layer. That is, the resistance to image blocking when recording an image may be improved when the recording medium includes the layer containing a pigment over the side opposite to the side having the image recording layer.

When the support includes the polyolefin resin layer and the undercoat layer at one side of the base paper, the polyolefin resin layer and the undercoat layer may be disposed over the side having the layer containing a pigment, or may be disposed over the other side, i.e., the side different from the side having the layer containing a pigment. In the image recording medium obtained using this support, the image recording layer may be preferably disposed over a side different from the side having the layer containing a pigment. Accordingly, from the viewpoint of image clarity, the layer containing a pigment may be preferably disposed over a side different from the side having the polyolefin resin layer and the undercoat layer, such that the polyolefin resin layer and the undercoat layer are disposed over the same side as at least the image recording layer.

In embodiments, when the polyolefin resin layer, the undercoat layer and the layer containing a pigment are disposed over the same side of the base paper, the layer containing a pigment is preferably disposed over the undercoat layer, from the viewpoints of improving blocking resistance of the image recording medium, and suitability to conveyance of the recording medium in the image recording apparatus.

In embodiments, the support may preferably have a structure in which the polyolefin resin layer and the undercoat layer each are disposed over both sides of the base paper, and the layer containing a pigment is disposed over the polyolefin resin layer and the undercoat layer over one side of the base paper.

The polyolefin resin layer may provide water resistance to the support. Concerning the water absorption, specifically, the support preferably has a water absorption degree in terms of Cobb size of 5 g/cm² or lower, more preferably 2 g/cm² or lower, and even more preferably 1 g/cm² or lower. The Cobb size water absorption degree is a value obtained by measuring the amount of water absorbed when a sample is contacted with pure water for 30 seconds, in accordance with JIS P8140, which is incorporated herein by reference. JIS P8140 substantially corresponds to ISO 535:1991.

Base Paper

The main raw material of the base paper may be a wood pulp. When making the base paper, synthetic pulp such as polypropylene or synthetic fiber such as nylon or polyester may be optionally used in addition to the wood pulp. Any of LBKP, LBSP, NBKP, NBSP, LDP, NDP, LUKP, or NUKP may be used as the wood pulp. In embodiments, it may be preferable to increase the total amount of LBKP, NBSP, LBSP, NDP and LDP, which have high contents of short fibers. In embodiments, the proportion of LBSP and/or LDP may be preferably from 10% by mass to 70% by mass.

The pulp may be preferably a chemical pulp (such as sulfate pulp or sulfite pulp) which has a less impurity content. A pulp of which whiteness has been improved by bleaching treatment may be also useful.

In embodiments, one or more of the following agents may be appropriately added into the base paper as necessary: a sizing agent such as a high fatty acid or an alkylketene dimer, a white pigment such as calcium carbonate, talc, or titanium oxide, a paper-strength enhancing agent such as starch, polyacrylamide, or polyvinyl alcohol, a fluorescent whitening agent, a moisturizing agent such as a polyethylene glycol, a dispersant, a softener such as quaternary ammonium, or the like.

The freeness of the pulp used for paper-making may be preferably from 200 mL to 500 mL in terms of C.S.F (Canadian Standard Freeness). Further, concerning the fiber length after beating, the sum of the percentage by mass of the pulp remaining on a 24-mesh screen and the percentage by mass of the pulp remaining on a 42-mesh screen according to JIS P-8207 (which is incorporated herein by reference) may be preferably from 30% by mass to 70% by mass. In addition, the percentage by mass of the pulp remaining on a 4-mesh screen may be preferably 20% by mass or less.

The basis weight of the base paper may be preferably from 30 g/m² to 250 g/m², and more preferably from 50 g/m² to 200 g/m². The thickness of the base paper may be preferably from 40 μm to 250 μm. High smoothness may also be rendered to the base paper by subjecting the base paper to calender treatment during or after paper-making The density of the base paper is generally from 0.7 g/cm³ to 1.2 g/cm³ (according to JIS P8118, the disclosure of which is incorporated herein by reference). JIS P8118 substantially corresponds to ISO 534:1988. The stiffness of the base paper may be preferably from 20 g to 200 g under the conditions according to JIS P8143, which is incorporated herein by reference.

In embodiments, a surface size agent may be coated on the surface of the base paper, and examples of the size agent which is similar to the sizing agent which can be added to the base paper. In embodiments, the pH of the base paper may be from 5 to 9 when measured by a hot water extraction method provided by JIS P-8113, the disclosure of which is incorporated by reference herein.

One or both sides of the base paper may be subjected to various kinds of surface treatments or undercoat treatments for the purpose of improving adhesion with the layer to be disposed thereon. Examples of the surface treatment include a patterning treatment, such as a gloss surface treatment, a fine surface treatment described in JP-A No. 55-26507, a matte surface treatment, or a silky surface treatment, and an activation treatment such as a corona discharge treatment, a flame treatment, a glow discharge treatment, or a plasma treatment. Examples of the undercoat treatment include the methods such as those described in JP-A No. 61-846443. Each of these surface treatments may be performed singly, or may be arbitrarily combined with at least one other surface treatment. For example, an activation treatment may be performed after performing a patterning treatment or the like; or an undercoat treatment may be performed after performing an activation treatment or the like.

Polyolefin Resin Layer

The support includes a polyolefin resin layer, which is a resin layer containing, preferably as a main component thereof, a polyolefin resin layer on one or both sides of the base paper. There is no particular limitation to the position at which the polyolefin resin layer resides as long as it is on one or both sides of the base paper and is other than an outermost layer. In embodiments, the polyolefin resin layer may be an intermediate layer.

Examples of the polyolefin resin used in the polyolefin resin layer include polyethylene and polypropylene. The polyethylene to be used may be a high density polyethylene (HDPE), low density polyethylene (LDPE), or linear low density polyethylene (L-LDPE). From the viewpoint of the stiffness of a support for photographic paper, it is preferable to use polypropylene, high density polyethylene (HDPE), or linear low density polyethylene (L-LDPE). The resin may be used alone, or a mixture of two or more thereof may be used. Here, high density polyethylene and low density polyethylene are defined in JIS K6748: 1995, which is incorporated herein by reference. High density polyethylene is polyethylene having a density of 0.942 g/cm³ or higher, and low density polyethylene is polyethylene having a density of from 0.910 g/cm³ to 0.930 g/cm³. Linear low density polyethylene is polyethylene defined in JIS K6899-1: 2000, which is incorporated herein by reference.

Generally, a polyolefin resin layer is often formed using low density polyethylene. In embodiments, in view of improving thermal resistance of the support, it may be preferable to use propylene, a blend of polypropylene and polyethylene, high density polyethylene, or a blend of high density polyethylene and low density polyethylene. Particularly, from the viewpoints of costs, laminate suitability and the like, it may be preferable to use a blend of high density polyethylene and low density polyethylene.

For example, a blend of high density polyethylene and low density polyethylene at a blend ratio (high density polyethylene/low density polyethylene in terms of mass ratio) of from 1/9 to 9/1 may be used. The blend ratio may be preferably from 2/8 to 8/2, and more preferably from 3/7 to 7/3.

The molecular weight of polyethylene is not particularly limited. In embodiments, the high density polyethylene and the low density polyethylene each may preferably have a melt index within a range of from 1.0 g/10 min to 40 g/10 min, and each may preferably have extrusion suitability.

The method of forming the polyolefin resin layer on one or both sides of the base paper is not particularly limited, and may be suitably selected depending on the purpose. For example, the polyolefin resin layer may be formed by any of the following (i) to (iv): (i) dry-laminating, or adhering, a polyolefin film onto the base paper, (ii) coating a polyolefin resin on the base paper using an organic solvent, (iii) aqueous-coating a polyolefin resin on the base paper using a polyolefin emulsion, (iv) impregnating the base paper with a polyolefin emulsion, or (v) melt-coating a polyolefin resin on the base paper. From the points of productivity, the polyolefin resin layer may be preferably formed by melt-extrusion coating.

The thickness of the polyolefin resin layer is not particularly limited. In embodiments, from the viewpoints of smoothness and water resistance, the thickness of the polyolefin resin layer may be preferably from 1 μm to 50 μm, more preferably from 5 μm to 35 μm, even more preferably from 10 μm to 20 μm, and further preferably from 10 μm to 18 μm. The thickness of the polyolefin resin layer referred herein is a value determined by cutting the polyolefin resin layer using a microtome (trade name: MICROTOME RM2165, manufactured by LEICA) to obtain a slice and measuring the thickness of the slice using an optical microscope (trade name, OPTICAL MICROSCOPE BX-60, manufactured by OLYMPUS CORPORATION).

The surface roughness (SRa) of the polyolefin resin layer is not particularly limited. In embodiments, the surface roughness (SRa) of the polyolefin resin layer may be from 0.02 μm to 0.20 μm with a frequency of from 0.2 mm to 0.3 mm. When the SRa is within the range, image clarity and smoothness of the recording medium may be improved, and surface defects of the recording medium may be easily suppressed.

The surface roughness of the polyolefin resin layer herein means a value measured by “NEW VIEW 5022” (trade name, manufactured by Zygo KK).

In embodiments, the polyolefin resin layer has both the thickness of from 10 μm to 18 μm and the surface roughness of from 0.02 μm to 0.20 μm at a frequency of from 0.2 mm to 0.3 mm. When the polyolefin resin layer has the thickness and the SRa which are both within the respective ranges, image clarity and smoothness of the recording medium may be improved, and surface defects of the recording medium may be suppressed.

In embodiments, the polyolefin resin layer may preferably contain a white pigment or a fluorescent whitening agent, if necessary, in addition to the polyolefin resin.

The fluorescent whitening agent is a compound that has absorption in the near ultraviolet region and emits fluorescence at an emission wavelength of from 400 nm to 500 nm. Known fluorescent whitening agent may be used without particular limitations. Preferable examples of the fluorescent whitening agent include the compounds described in “The Chemistry of Synthetic Dyes”, volume V, chapter 8, edited by K. VeenRataraman. Specific examples of the fluorescent whitening agent include a stilbene compound, a coumalin compound, a biphenyl compound, a benzoxazoline compound, a naphthalimide compound, a pyrazoline compound, and a carbostyril compound. More specific examples include WHITE FULFAR PSN, PHR, HCS, PCS, and B (trade names, all manufactured by Sumitomo Chemical Co., Ltd.), and UVITEX-OB (trade name, manufactured by Ciba-Geigy Co., Ltd.).

Examples of the white pigment include titanium oxide, calcium carbonate, barium sulfate, and zinc oxide. Among these, titanium oxide may be preferable from the point of shielding properties.

The content of the white pigment or the fluorescent whitening agent in the polyolefin resin layer is preferably from 0.1 g/m² to 8 g/m², and more preferably from 0.5 g/m² to 5 g/m². When the content is lower than 0.1 g/m², light transmittance of the support may become high. When the content exceeds 8 g/m², cracking of the surface of the support may occur, and handling properties such as adhesion resistance may deteriorate.

Latex-Containing Layer

The support includes at least one latex-containing layer (a undercoat layer containing a latex) over the polyolefin resin layer formed over one side or both sides of the base paper. The layer containing a latex herein means a layer containing a latex which is in a dispersed state or a layer containing a latex which is in a dried state.

The temperature of the heating treatment using the heating and pressurizing unit of the cooling-separation belt-fixing smoother apparatus may be lowered and the image clarity may be improved by providing the undercoat layer by applying (preferably by coating) the latex over the polyolefin resin layer. Further, when the support has the undercoat layer, the support may have better water resistance than that of supports having other layers formed for improving adhesiveness (such as a gelatin layer). Further, the support having the undercoat layer may not be necessarily required to be subjected to a surface treatment such as corona discharging.

The kind of the latex used for the undercoat layer is not particularly limited, and any known water-dispersible latex may be used. One kind of the latex may be used singly or two or more kinds thereof may be used in combination.

Any conventional-known component may be used in combination with the latex in the latex-containing layer as long as it can be used with the latex.

The water-dispersible latex is a dispersion prepared by dispersing a hydrophobic polymer insoluble or slightly soluble in water in the form of fine particles into an aqueous dispersion medium. The dispersion state thereof may be a state in which the polymer is emulsified in the dispersion medium, or a state in which emulsion polymerization has been carried out, or a state of a micelle dispersion, or a state in which the polymer molecules have in part hydrophilic structures and their molecular chains are in a molecular dispersion. Such water-dispersible latexes are described in detail in, for example, “Gosei Jushi Emulsion”, edited by Taira Okuda & Hiroshi Inagaki, published by Kobunshi Kankokai (1978); “Gosei Latex no Oyo”, edited by Takaaki Sugimura, Yasuo Kataoka, Sohichi Suzuki & Keiji Kasahara, published by Kobunshi Kankokai (1993); and “Gosei Latex no Kagaku,” written by Sohichi Muroi, published by Kobunshi Kankokai (1970).

Specific examples of the latex include an acrylic latex, an acrylic silicone latex, an acryl-epoxy latex, an acryl-styrene latex, an acryl-urethane latex, a styrene-butadiene latex, an acrylonitrile-butadiene latex, a polyester-urethane latex, and a vinyl acetate latex.

In embodiments, in view of improving image clarity and film strength, the latex may be preferably include at least one selected from a urethane latex (such as an acryl-urethane latex or a polyester-urethane latex), an acrylic silicone latex, and an acryl styrene latex, and may be more preferably include a urethane latex.

The number average molecular weight of the latex in the thermoplastic resin is preferably from 300 to 1,000,000, and more preferably about 500 to 100,000. When the latex has a number-average molecular weight of 300 or higher, the adhesiveness between the polyolefine resin layer and the image recording layer may be assured. When the latex has a number-average molecular weight of 1,000,000 or lower, the latex may have dispersion stability and viscosity which are suitable for production.

The acrylic latex used may be a commercially available product. Examples thereof include water-dispersible latexes of resins such as: acrylic resins such as CEVIAN A4635, 46583 and 4601 (trade names, manufactured by DAICEL CHEMICAL INDUSTRIES, LTD.) and NIPOL Lx 811, 814, 821, 820 and 857 (trade names, manufactured by ZEON CORPORATION). In particular, the acrylic emulsions of acrylic silicone latexes disclosed in JP-A Nos. 10-264511, 2000-43409, 2000-343811 and 2002-120452, which may be commercially available products as, for example, AQUABRID series UM7760, UM7611 and UM4901, and AQUABRID 903, AQUABRID ASi-86, AQUABRID ASi-89, AQUABRID ASi-91, AQUABRID ASi-753, AQUABRID 4635, AQUABRID 4901, AQUABRID MSi-04S, AQUABRID AU-124, AQUABRID AU-131, AQUABRID AEA-61, AQUABRID AEC-69 and AQUABRID AEC-162 (trade names, manufactured by manufactured by DAICEL CHEMICAL INDUSTRIES, LTD.), may also be preferably used.

Examples of commercially available polyester-urethane latexes include HYDRAN AP series (for example, HYDRAN AP-20, HYDRAN AP-30, HYDRAN AP-30F, HYDRAN AP-40(F), HYDRAN AP-50LM, HYDRAN APX-101H, HYDRAN APX-110 and HYDRAN APX-501 (trade names) manufactured by DIC CORPORATION.

In embodiments, the thermoplastic resin may be one selected from those listed above is preferably used, and may be a mixture of two or more elected from those listed above.

The glass transition temperature (Tg) of the thermoplastic resin used may be preferably from −20° C. to 70° C., and more preferably from −5° C. to 50° C. When the Tg is within the foregoing range, desired smoothness and image clarity may be easily obtained without setting a calendering temperature set at a considerably high value adjusted to excessively high Tg as well as without causing adhering of the thermoplastic resin to a belt member which may deteriorate surface condition of the recording medium.

The minimum film-formation temperature (MFT) of the thermoplastic resin, which is preferably in a form of particles of a latex, may be preferably from −20° C. to 50° C., and more preferably from 0° C. to 40° C. When the MFT at which film formation can be performed is within the foregoing range, desired smoothness and image clarity may be easily obtained without setting a calendering temperature set at a considerably high value adjusted to excessively high Tg. Although a layer formed by simply applying a liquid (such as a coating liquid) is not necessarily has favorable smoothness, it may be made smooth by being subjected to a cooling-separation treatment using a cooling-separation-belt-fixing smoother apparatus.

The method of forming the undercoat layer on the polyolefin resin layer is not particularly limited, and may be suitably selected depending on the purpose. For example, the undercoat layer may be formed by applying a water-dispersible latex on the polyolefin resin layer and drying the coated liquid.

The latex which forms the undercoat layer is preferably applied in an amount of from 1 g/m² to 10 g/m², and more preferably from 3 g/m² to 7 g/m², in terms of solid content (specifically, in terms of an amount of the thermoplastic resin). When the applied amount of the latex is 1 g/m² or more, image clarity may be improved. When the amount of the pigment is 10 g/m² or less, brittleness may be suppressed.

Pigment-Containing Layer

In embodiments, it may be preferable that the support further includes a pigment-containing layer (hereinafter, referred to as a “back coat layer” in some cases) at one side of the base paper. This configuration may improve blocking resistance of the recording medium which has the image forming layer of the support.

The pigment used in the back coat layer is not particularly limited, and known organic pigments and inorganic pigments may be used. The pigment may be used singly, or a mixture of two or more thereof may be used.

Examples of pigments include inorganic white pigments such as precipitated calcium carbonate, ground calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudoboehmite, aluminum hydroxide, aluminum oxide (alumina), lithopone, zeolite, hydrated halloysite, magnesium carbonate, and magnesium hydroxide; and organic pigments such as styrene-based plastic pigments, acrylic plastic pigments, polyethylene, microcapsules, urea resins, and melamine resins. From the viewpoint of improving image density while maintaining transparency of the recording medium, a white pigment may be preferable.

The back coat layer may further contain at least one additive such as an aqueous binder, an oxidation inhibitor, a surfactant, a defoaming agent, an anti-foaming agent, a pH adjuster, a curing agent, a coloring agent, a fluorescent whitening agent, an antiseptic agent, or a water-resistant additive. Examples of the aqueous binder include water-soluble polymers such as a copolymer of styrene/maleic acid salt, a copolymer of styrene/acrylic acid salt, polyvinyl alcohol, silanol-modified polyvinyl alcohol, starch, cationized starch, casein, gelatin, carboxymethyl cellulose, hydroxyethyl cellulose, and polyvinylpyrrolidone; and water-dispersible polymers such as a styrene-butadiene latex and an acrylic emulsion.

The method of forming the back coat layer on the polyolefin resin layer is not particularly limited, and may be suitably selected depending on the purposes. For example, the back coat layer may be formed by coating a dispersion liquid in which a pigment is dispersed in water, followed by drying.

The amount of the pigment contained in the back coat layer may be preferably in a range of from 0.01 g/m² to 20 g/m², and more preferably from 0.1 g/m² to 10 g/m². When the amount of the pigment is 0.01 g/m² or more, blocking resistance may become excellent. When the amount of the pigment is 20 g/m² or less, brittleness may be suppressed.

The amount of the pigment contained in the back coat layer may be preferably 10% by mass or more, more preferably 14% by mass or more, and even more preferably 18% by mass or more, with respect to the total solid content of the back coat layer.

Cooling-Separation Treatment

The method of producing a recording medium include subjecting the support, which includes the polyolefin resin layer and the latex layer disposed on one or both sides of the base paper, to cooling-separation treatment by applying heat and pressure to a surface of the support using a heating and pressurizing unit in a cooling-separation belt-fixing smoother apparatus, cooling the surface, and then separating the surface from a belt member of the heating and pressurizing unit.

When the heating and pressurizing unit in the cooling-separation belt-fixing smoother apparatus is brought into contact with the support, the polyolefin resin layer and the undercoat layer are softened due to heating and deformed due to pressure. However, a support having excellent water resistance, excellent surface smoothness, favorable surface gloss, and reduced surface defects can be provided by taking a procedure including: applying heat and pressure under a temperature condition in which a blister (blister in the resin layer due to expansion caused by evaporation of moisture content contained in the base paper) does not occur; cooling the support to a temperature condition that allows the polyolefin resin layer to solidify; and then separating the support from the belt member.

In embodiments, in the cooling-separation, the latex-containing layer-side surface of the support may be preferably firstly heated and pressurized at a temperature of at least 60° C. and less than 100° C. by being contacted with the heating and pressurizing unit, cooled to a temperature of lower than 60° C., and then separated from the belt member of the heating and pressurizing unit. When the heating temperature employed in the heating and pressurizing is 60° C. or higher, the effects in support performance improvement achieved by the cooling-separation treatment may be sufficient. When the heating temperature employed in the heating and pressurizing is lower than 100° C., blisters may less tend to occur. This temperature range employed in the heating and pressurizing may be more preferably in a range of from 60° C. to 90° C. from the viewpoints of further improving the image clarity and further reducing surface defects of the recording medium prepared using the support. Here, the “heating temperature” means the temperature of the heating and pressurizing unit, and is a value obtained by measurement using a non-contact thermometer.

The heating and pressurizing involves applying pressure when the latex-containing layer-side surface of the support is contacted with the heating and pressurizing unit. The method of applying pressure is not particularly limited. It is preferable to apply a nip pressure. The nip pressure is preferably from 1 kgf/cm² to 100 kgf/cm², and more preferably from 5 kgf/cm² to 30 kgf/cm², in view of efficiently producing a support having excellent water resistance, excellent surface smoothness, favorable surface gloss, and reduced surface defects.

The latex-containing layer-side surface of the support is heated and pressurized using the heating and pressurizing unit, and thereafter is cooled. The cooling temperature may be lower than 60° C., at which sufficient solidification of the polyolefin resin layer may occur. In embodiments, the cooling temperature may be preferably at least 25° C. and less than 60° C. from the viewpoints of productivity and economical efficiency. Here, the “cooling temperature” means the temperature of the belt member, and is a value obtained by measurement using a non-contact thermometer.

The method of cooling the support is not particularly limited. The cooling may be preferably performed by using a cooling device that is provided to perform cooling subsequent to the application of heat and pressure by the heating and pressurizing unit, from the viewpoint of productivity.

The conveyance speed of the belt of the belt-fixing smoother apparatus when applying heat and pressure to the support or when cooling the support is not particularly limited. In embodiments, the conveyance speed of the belt may be set so as to achieve a desired target temperature of the polyolefin resin layer, in consideration of, for example, the temperature of the heating and pressurizing unit, the method of applying pressure, or the temperature of the cooling member in the cooling device.

Heating and pressurizing unit in Cooling-separation belt-fixing smoother apparatus

There is no particular limitation on the heating and pressurizing unit in the cooling-separation belt-fixing smoother apparatus, which is used for the cooling-separation treatment. For example, the heating and pressurizing unit to be used may be a combination of a heating roller, a pressurization roller, and an endless belt member.

In embodiments, it may be preferable that the belt member of the heating and pressurizing unit includes, at a surface thereof, a thin film which includes at least one selected from the group consisting of a silicone rubber, a fluoro rubber, a silicone resin, and a fluorocarbon resin. In embodiments, it is preferable that the belt member includes, at a surface thereof, a fluorocarbon siloxane rubber layer having a uniform thickness. In embodiments, it is also preferable that the belt member includes, at a surface thereof, a silicone rubber layer having a uniform thickness and a fluorocarbon siloxane rubber layer which is further provided on the surface of the silicone rubber layer.

The fluorocarbon siloxane rubber preferably has, in its main chain thereof, at least one of a perfluoroalkyl ether group or a perfluoroalkyl group. The fluorocarbon siloxane rubber is preferably a cured product of a fluorocarbon siloxane rubber composition including the following components (A) to (D) of: (A) a fluorocarbon polymer containing, as a main component, a fluorocarbon siloxane represented by the following Formula (1) and having an aliphatic unsaturated group; (B) an organopolysiloxane and/or a fluorocarbon siloxane, each of which having two or more ═SiH groups in a molecule thereof, wherein the content of the SiH groups being from one to four times (by mole) as high as the content of aliphatic unsaturated groups in the fluorocarbon siloxane rubber composition; (C) a filler; and (D) an effective amount of a catalyst.

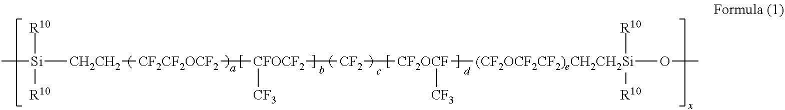

In Formula (1), R¹⁰ represents an unsubstituted or substituted monovalent hydrocarbon group which preferably has from 1 to 8 carbon atoms. R¹⁰ represents more preferably an alkyl group having from 1 to 8 carbon atoms or an alkenyl group having from 2 or 3 carbon atoms, and particularly preferably a methyl group. In Formula (1), a and e each independently represent 0 or 1; b and d each independently represent an integer of from 1 to 4; c represents an integer of from 0 to 8; and x represents an integer of 1 or greater, and preferably an integer of from 10 to 30.

Specific examples of the Component (A) include a polymer represented by the following Formula (2).

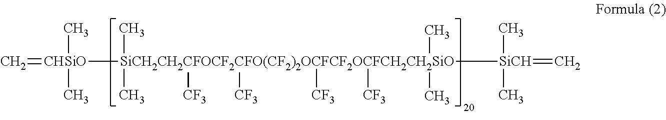

In the component (B), examples of the organopolysiloxane having ═SiH groups include an organohydrogenpolysiloxane in which the number of hydrogen atoms bonded to silicon atoms in a molecule thereof is at least two.

In the fluorocarbon siloxane rubber composition, since the fluorocarbon polymer as the component (A) has an aliphatic unsaturated group, the organohydrogenpolysiloxane described above may be used as a curing agent. In this case, a cured product may be formed by an addition reaction between an aliphatic unsaturated group in the fluorocarbon siloxane and a hydrogen atom bonded to a silicon atom in the organohydrogenpolysiloxane.

The organohydrogenpolysiloxane may be selected from various organohydrogenpolysiloxanes which are used for addition-curable silicone rubber compositions.

Generally, the organohydrogenpolysiloxane described above is preferably added such that the number of ═SiH groups thereof is at least one, preferably from one to five, per one aliphatic unsaturated hydrocarbon group of the fluorocarbon siloxane of the component (A).

Further, the fluorocarbon siloxane having ═SiH groups preferably include a unit represented by Formula (1) described above or a unit that is the same as a unit represented by Formula (1) except that R¹⁰ represents a dialkylhydrogensiloxy group, and a terminal of the fluorocarbon siloxane is preferably an SiH group such as a dialkylhydrogensiloxy group or a silyl group. Examples of the fluorocarbon siloxane include a compound represented by the following Formula (3).

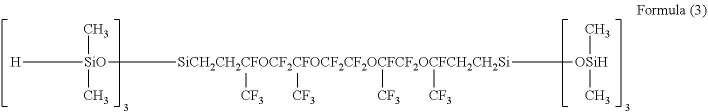

The filler as the component (C) may be selected from various kinds of fillers used in general silicone rubber compositions. Examples of the filler include reinforcing fillers such as fumed silica, precipitated silica, carbon powder, titanium dioxide, aluminum oxide, quartz powder, talc, sericite, and bentonite; and fibrous fillers such as asbestos, glass fibers, and organic fibers.

The catalyst as the component (D) may be a catalyst for addition reaction known in the art. Specific examples thereof include chloroplatinic acid; alcohol-modified chloroplatinic acid; complex of chloroplatinic acid and olefin; platinum black or palladium retained on a carrier such as alumina, silica, or carbon; elements belonging to Group VIII of the Periodic Table or compounds thereof such as complexes of rhodium and olefin, chlorotris(triphenylphosphine)rhodium (Wilkinson's catalyst), and rhodium(III) acetylacetonate. A complex employed as the catalyst, such as those described above, is preferably used in a form of solution in which the complex is dissolved in a solvent such as an alcohol solvent, an ether solvent, or a hydrocarbon solvent.

Various agents may be mixed into the fluorocarbon siloxane rubber composition, within a range at which improvement in solvent resistance is not impaired. For example, one or more of the following agents may be added as necessary: a dispersant such as diphenylsilanediol, dimethylpolysiloxane which has a low polymerization degree and of which molecular chain terminal is blocked by a hydroxyl group, or hexamethyl disilazane; a thermal resistance-enhancing agent such as ferrous oxide, ferric oxide, cerium oxide, or iron octylate; and a coloring agent such as a pigment.

The belt member may be obtained by covering the surface of a belt, which may be made of a heat-resistant resin or a metal, with the fluorocarbon siloxane rubber composition, and then thermally curing the rubber composition. Here, the fluorocarbon siloxane rubber composition may be diluted with a solvent such as m-xylene hexafluoride or benzotrifluoride, as necessary, to prepare a coating liquid, and then the coating liquid may be coated according to a general coating method such as spray coating, dip coating, or knife coating. The temperature and time for the thermal curing may be suitably selected. In general, the temperature and time for the thermal curing may be selected from a temperature range of from 100° C. to 500° C. and a time range of from 5 seconds to 5 hours, in consideration of the kind and production method of the belt.

The thickness of the fluorocarbon siloxane rubber layer that forms a surface of the belt member is not particularly limited. The thickness may be usually from 20 μm to 500 μm, and may be preferably from 40 μm to 200 μm.

The surface roughness (arithmetic average roughness (Ra)) of the belt member may be preferably 20 μm or less, more preferably 5 μm or less, and even more preferably 1 μm or less, from the point of efficiently manufacturing a support having excellent surface smoothness and favorable surface gloss. The arithmetic average roughness may be measured based on JIS B0601, B0651, and B0652, the disclosure of which are incorporated herein by reference. JIS B0601 is equivalent to ISO 4287:1997, and JISB0651 is equivalent to ISO 3274:1996.

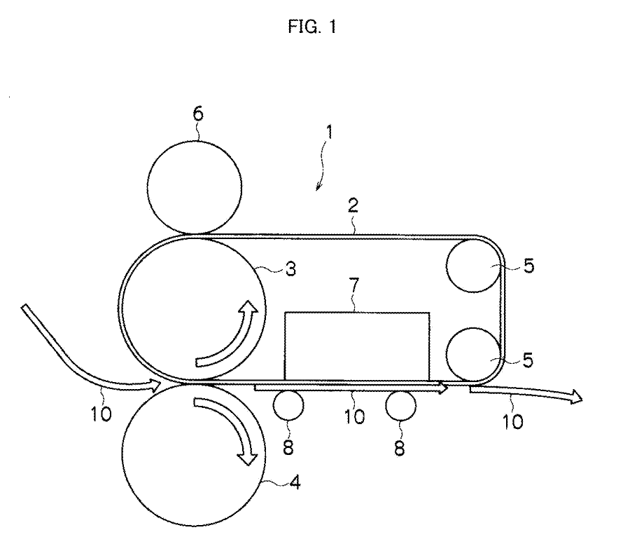

The belt member is not particularly limited. An endless belt in a cooling-separation belt-fixing smoother apparatus may be preferable. The cooling-separation belt-fixing smoother apparatus is not particularly limited, and may be suitably selected depending on the purposes. For example, an embodiment as shown in FIG. 1 is preferable, in which a cooling device for the belt member is provided at a downstream-side portion of the fixation unit, and allows a post treatment for cooling separation whereby the temperature is adjusted to a low temperature when separating a support. In the above cooling device, cooling may be performed so as to cool the polyolefin resin layer to a temperature of lower than 60° C., thereby allowing sufficient solidification of the polyolefin resin layer.

The belt member is particularly preferably an endless belt due to its capability of efficient continuous processing of the support.

The surface roughness of the support (arithmetic average roughness (SRa)) that has been subjected to the cooling-separation treatment may be preferably 20 μm or less, and more preferably 15 μm or less. The arithmetic average roughness is measured using NEW VIEW 5022 (trade name, manufactured by ZYGO Corporation) under the conditions of: cut off value of from 0.05 mm to 0.06 mm; measurement length of 1 cm in X direction and 1 cm in Y direction; and objective lens of 2.5 magnifications.

Image Recording Layer

In the method of producing a recording medium, an image recording layer is formed on a surface at a side of the support which has been subjected to the cooling-separation treatment.

The image recording layer may be formed by applying, onto the support, a liquid including a composition for an image recording layer (hereinafter, referred to as an “image recording layer forming liquid” in some cases), and then drying the coating layer formed by the application of the image recording layer forming liquid. The application of the image recording layer forming liquid may be performed according to a known coating method using, for example, an extrusion die coater, an air doctor coater, a blade coater, a rod coater, a knife coater, a squeeze coater, a reverse roll coater, or a bar coater.

The image recording layer is not particularly limited as long as the layer is capable of image formation. In embodiments, the image recording layer may be preferably an ink receiving layer including inorganic fine particles and a water-soluble resin, with a view to achieving the effects in improvements in surface gloss and image clarity and in reduction of surface defects. The ink receiving layer may be formed by applying, onto the support, a liquid containing at least inorganic fine particles and a water-soluble resin (hereinafter, referred to as an “ink receiving layer forming liquid” in some cases), and then drying the formed coating layer.

In embodiments, in combination with the ink receiving layer forming liquid, a basic solution having a pH of 7.1 or higher may be preferably applied onto the support. In this process, the ink receiving layer forming liquid and the basic solution may be applied onto the support at the same time or during drying of the coating layer formed by the application of the ink receiving layer forming liquid but before the coating layer shows falling-rate drying. In other words, the ink receiving layer may favorably be formed by introducing the basic solution having a pH of 7.1 or higher, during the period in which the coating layer shows a constant-rate drying after the application of the ink receiving layer forming liquid.

The basic solution having a pH of 7.1 or higher may include a crosslinking agent, if necessary. The basic solution having a pH of 7.1 or higher may accelerate curing of the ink receiving layer when the basic solution having a pH of 7.1 or higher is used as an alkali solution. The pH of the basic solution is preferably 7.5 or higher, and particularly preferably 7.9 or higher. When the pH is too close to the acidic side, the crosslinking reaction of the water-soluble resin caused by the crosslinking agent may not proceed sufficiently, as a result of which bronzing may occur and/or defects such as cracking may occur in the ink receiving layer.

The basic solution having a pH of 7.1 or higher may be prepared, for example, by adding, to ion-exchange water, a metal compound (for example, in an amount of from 1% to 5%), a basic compound (for example, in an amount of from 1% to 5%), and, if necessary, p-toluenesulfonic acid (for example, in an amount of from 0.5% to 3%), and thoroughly stirring the resulting mixture. Here, “%” for each compound means % by mass with respect to the total mass of the basic solution.

The period expressed by “before the coating layer shows falling-rate drying” usually refers to a period of several minutes from immediately after the application of the coating liquid, and, in this period, the applied coating layer shows the phenomenon of “constant-rate drying” whereby the solvent (dispersion medium) content in the coating layer decreases in proportion to a lapse of time. With respect to the period during which the constant-rate drying is observed, Kagaku Kogaku Binran (Handbook of Chemical Technology), pages 707-712, MARUZEN Co., Ltd. (Oct. 25, 1980) may be referenced, for example.

As described above, after the application of an ink receiving layer forming liquid, the coating layer is dried until the coating layer shows a falling-rate drying. The drying may be performed generally at from 40° C. to 180° C. for from 0.5 minutes to 10 minutes (preferably from 0.5 minutes to 5 minutes). Although the drying time naturally varies with the coating amount, the range specified above may be usually appropriate.

In consideration that the ink receiving layer is desired to have an absorption capacity that allows absorption of all ink droplets, the thickness of the ink receiving layer prepared by drying the ink receiving layer forming liquid on the support may be determined in relation to the porosity of the ink receiving layer. For example, when the amount of ink is 8 nL/mm² and the porosity is 60%, the thickness of the ink receiving layer may be about 15 μm or more. From this viewpoint, the thickness of the ink receiving layer may be preferably from 10 μm to 50 μm.

The pore diameter of the ink receiving layer is preferably from 0.005 μm to 0.030 μm, and more preferably from 0.01 μm to 0.025 μm, in terms of median diameter.

The porosity and the pore median diameter may be measured using a mercury porosimeter (trade name: PORESIZER 9320-PC2, manufactured by Shimadzu Corporation).

The recording medium having the ink receiving layer containing inorganic fine particles and a water-soluble resin may be suitable for use in inkjet recording, which involve recording by ejecting ink droplets according to an inkjet method, due to enhanced effects thereof in improvement of glossiness and image clarity and in reduction of surface defects.

Inorganic Fine Particles

Examples of the inorganic fine particles include silica fine particles, colloidal silica, titanium dioxide fine particles, barium sulfate fine particles, calcium silicate fine particles, zeolite fine particles, kaolinite fine particles, halloysite fine particles, mica fine particles, talc fine particles, calcium carbonate fine particles, magnesium carbonate fine particles, calcium sulfate fine particles, boehmite fine particles, and pseudoboehmite fine particles. Among these, silica fine particles are preferable.

Silica fine particles may have high efficiency with respect to absorption and retaining of ink, as a result of their particularly high specific surface area. Further, since the silica fine particles have a low refractive index, a transparent ink receiving layer can be provided when the silica fine particles are dispersed to an appropriate microparticle diameter, and high color density and favorable color exhibiting properties can be provided. The transparency of the ink receiving layer may be important from the viewpoints of obtaining high color density and favorable color exhibiting properties and glossiness.

The average primary particle diameter of the inorganic fine particles is preferably 20 nm or less, more preferably 15 nm or less, and particularly preferably 10 nm or less. When the average primary particle diameter is 20 nm or less, ink absorption characteristics may be effectively improved and, at the same time, glossiness of the surface of the ink receiving layer may be enhanced. The specific surface area of the inorganic fine particles as determined by the BET method is preferably 200 m²/g or higher, more preferably 250 m²/g or higher, and particularly preferably 380 m²/g or higher. When the specific surface area of the inorganic fine particles is 200 m²/g or higher, the ink receiving layer may have high transparency and high image density.

The BET method is a method of measuring a surface area of powder using a vapor-phase adsorption method, and is a method of determining a specific surface area, that is the total surface area per 1 g of a specimen, from an adsorption isotherm. In the BET method, nitrogen gas is often used as a gas to be adsorbed, and the adsorption amount is most widely determined from a change in pressure or volume of the adsorbed gas. An equation proposed by Brunauer, Emmett, and Teller, which is called a BET equation, is the most famous equation representing an isotherm of multimolecular adsorption. The BET equation is widely used for determining surface area. An adsorption amount is determined on the basis of the BET equation, and the resulting adsorption amount is multiplied by an area on the surface occupied by one adsorbed molecule, whereby the surface area is determined.

Silica fine particles have silanol groups on surfaces thereof. The particles easily adhere to each other through hydrogen bonding of the silanol groups, and particles are adhered to one another also via an interaction between the water-soluble resin and the silanol groups. Hence, when the average primary particle diameter of silica fine particles is 20 nm or less as described above, the ink receiving layer may have a structure having high porosity and high transparency, and the ink receiving layer may have effectively improved ink absorption characteristics.

In general, the silica fine particles are roughly classified into wet process silica particles and dry process (vapor-phase-method) silica particles according to the production method thereof. In the wet process, a method of producing hydrous silica by forming active silica by acid decomposition of a silicate, polymerizing the active silica to a certain degree, and allowing the resultant polymerized product to aggregate and precipitate, is widely used. In the vapor-phase-method, a method of producing anhydrous silica by high-temperature vapor-phase hydrolysis of a silicon halide (flame hydrolysis) or a method in which silica sand and coke are subjected to heat reduction and evaporation by arc in an electronic furnace and the resultant product is oxidized by air (arc process), are widely used. “Fumed silica” as used herein refers to anhydrous silica fine particles obtained by the vapor-phase-methods.

The fumed silica differs from the hydrous silica in density of silanol groups on the surface thereof, the presence or absence of pores, and the like, and exhibits different properties from those of the hydrous silica. The fumed silica is suitable for forming three-dimensional structures having high porosity, though the reason is not clear. It may be because, whilst the hydrous silica fine particles tend to closely aggregate (i.e., form aggregates) owing to high silanol densities of from 5 groups/nm² to 8 groups/nm² on the fine particle surface, the fumed silica particles form loose aggregates (i.e., flocculates) owing to low silanol densities of from 2 groups/nm² to 3 groups/nm² on the fine particle surface, which results in formation of a highly-porous structure.

In embodiments, the inorganic fine particles may be preferably fumed silica fine particles (anhydrous silica) obtained by the dry process described above, and may be more preferably silica fine particles having the silanol densities of from 2 groups/nm² to 3 groups/nm² on the fine particle surface. In embodiments, the inorganic fine particles most preferably used may be fumed silica having a specific surface area of 200 m²/g or more as determined by the BET method.

Water-Soluble Resin

Examples of the water-soluble resin include polyvinyl alcohol resins having a hydroxyl group as a hydrophilic group (for example, polyvinyl alcohol (PVA), acetoacetyl-modified polyvinyl alcohol, cation-modified polyvinyl alcohol, anion-modified polyvinyl alcohol, silanol-modified polyvinyl alcohol, and polyvinyl acetal), cellulose resins (for example, methyl cellulose (MC), ethyl cellulose (EC), hydroxyethyl cellulose (HEC), carboxymethyl cellulose (CMC), hydroxypropyl cellulose (HPC), hydroxyethyl methyl cellulose, and hydroxypropyl methyl cellulose), chitins, chitosans, starches, resins having an ether bond (for example, polyethylene oxide (PEO), polypropylene oxide (PPO), and polyvinyl ether (PVE)), and resins having a carbamoyl group (for example, polyacrylamide (PAAM), polyvinyl pyrrolidone (PVP), and polyacrylic acid hydrazide). Examples of the water-soluble resin further include polyacrylic acid, maleic acid resins, alginic acid, and gelatins, each of which has a carboxyl group and/or a salt thereof as a dissociative group.

Among the above resins, polyvinyl alcohol resins may be particularly preferable. Examples of polyvinyl alcohol resins include those described in Japanese Patent Publication (JP-B) Nos. 4-52786, 5-67432 and 7-29479, Japanese Patent No. 2537827, JP-B No. 7-57553, Japanese Patent Nos. 2502998 and 3053231, JP-A No. 63-176173, Japanese Patent No. 2604367, JP-A Nos. 7-276787, 9-207425, 11-58941, 2000-135858, 2001-205924, 2001-287444, 62-278080 and 9-39373, Japanese Patent No. 2750433, JP-A Nos. 2000-158801, 2001-213045, 2001-328345, 8-324105 and 11-348417. Further, examples of water-soluble resins other than polyvinyl alcohol resins include the compounds described in paragraphs [0011] to [0014] of JP-A No. 11-165461. The water-soluble resin may be used singly, or two or more there may be used in combination.

The content of the water-soluble resin may be preferably from 9% by mass to 40% by mass, and more preferably from 12% by mass to 33% by mass, with respect to the total solid content of the ink receiving layer.

The inorganic fine particle and the water-soluble resin are main components of the ink receiving layer. The inorganic fine particle may be composed of a single material or may be a mixture of plural materials. The water-soluble resin may be composed of a single material or may be a mixture of plural materials. The kind of the water-soluble resin which is used in combination with the inorganic fine particles may be selected from the viewpoint of improving image density with maintaining transparency. In embodiments, the water-soluble resin may be preferably a polyvinyl alcohol resin more preferably a polyvinyl alcohol resin having a saponification degree of from 70% to 100%, and further preferably a polyvinyl alcohol resin having a saponification degree of from 80% to 99.5%.

In embodiments, a water-soluble resin other than the above-described polyvinyl alcohol resin may be used in combination with the above-described polyvinyl alcohol resin. When used in combination, the content of the polyvinyl alcohol resin may be preferably 50% by mass or higher, and more preferably 70% by mass or higher with respect to the total content of water-soluble resins in the image receiving layer.

Content Ratio of Inorganic Fine Particles to Water-Soluble Resin

The content ratio by mass (PB ratio (x/y)) of the inorganic fine particles (x) to the water-soluble resin (y) may largely affect the film structure and the film strength of the ink receiving layer. In other words, a higher content ratio by mass (PB ratio) may provide a higher porosity, a higher pore volume, and a larger surface area (per unit mass) while density and strength may tend to decrease.

In embodiments, the content ratio (PB ratio (x/y)) in the ink receiving layer may be preferably in a range of from 1.5 to 10 from the viewpoints of suppressing a decrease in film strength and the cracks which can cause during drying due to excessively high PB ratios, and suppressing reducing ink absorbency which results from decrease in porosity due to an increased tendency for pores to be clogged by the resins, which is caused by excessively low PB ratios.

When passing through a conveyance system of an image recording apparatus, the recording medium may sometimes receive stress. Therefore, the ink receiving layer may be desired to have adequate film strength. Moreover, the adequate film strength of the ink receiving layer may be also desired from the viewpoint of supressing cracking, exfoliating, and the like of the ink receiving layer when the recording medium is cut into sheets. In view of the above, the content mass ratio (x/y) may be preferably 5 or lower, and, from the viewpoint of providing ability to rapidly absorb ink when the recording medium is used in an inkjet printer, the content mass ratio (x/y) may be more preferably 2 or higher.

For example, a porous film having a three-dimensional network structure having secondary particles of the silica fine particles as the network chains can be easily formed by completely dispersing fumed silica having an average primary particle diameter of 20 nm or less (x) and a water-soluble resin (y) in an aqueous solution at a content mass ratio (x/y) of from 2 to 5, applying the resultant solution onto the support, and then drying the formed coating layer. The resulted porous film may have an average pore diameter of 30 nm or less, a porosity of from 50% to 80%, a specific pore volume of 0.5 mL/g or more, and a specific surface area of 100 m²/g or higher.

Method of Preparing Ink Receiving Layer Forming Liquid

The ink receiving layer forming liquid may be formed, for example, using the following methods. When fumed silica is used as the inorganic fine particles, fumed silica and a dispersant are added into water (for example, the content of the vapor-phase silica in water is from 10% by mass to 20% by mass) and the resultant mixture is dispersed using a head-on-collision high pressure homogenizer (for example, “ULTIMIZER” (trade name, manufactured by Sugino Machine Limited)) under a high pressure condition of, for example, 120 MPa (preferably, from 100 MPa to 200 MPa). Subsequently, a boron compound, an aqueous solution of PVA (for example, in an amount such that the mass of PVA is about one third of the mass of the fumed silica), and additional components are added thereto, and the resulting mixture is stirred, whereby an ink receiving layer forming liquid is prepared. The resulting ink receiving layer forming liquid is in a homogeneous sol state. When coating this ink receiving layer forming liquid onto a support, a porous ink receiving layer having a three-dimensional network structure can be formed.

After mixing the above fumed silica and the dispersant with water, the resulting mixture liquid may be dispersed using a disperser so as to decrease the particle size, as a result of which a water dispersion liquid containing silica fine particles having an average particle diameter of from 50 nm to 300 nm can be obtained. Examples of the disperser to be used for obtaining the water dispersion liquid include various kinds of known dispersers such as a high speed rotating disperser, a medium stirring disperser (for example, a ball mill or a sand mill), an ultrasonic disperser, a colloid mill disperser and a high pressure disperser. In order to efficiently disperse particles forming a lump, a stirring disperser, a colloid mill disperser and a high pressure disperser may be preferable, and particularly, a head-on-collision high pressure disperser and an orifice-passing high pressure disperser may be preferable.

Solvents used in the preparation may be selected from water, an organic solvent, and a mixed solvent thereof. Examples of organic solvents which can be used for the coating include alcohols such as methanol, ethanol, n-propanol, i-propanol, or methoxy propanol, ketones such as acetone or methyl ethyl ketone, tetrahydrofuran, acetonitrile, ethyl acetate, and toluene.

The dispersant may be a cationic polymer. Examples of the cationic polymer include organic mordants, polymers for coloring, and polyimines. A silane coupling agent may be also used as the dispersant. The amount of the dispersant to be added may be preferably from 0.1% by mass to 30% by mass, and more preferably from 1% by mass to 10% by mass, with respect to the total content of the fine particles in the ink receiving layer forming liquid.

Additional Components

In addition to the above components, the image recording layer may further include other known additives, as necessary, such as crosslinking agents, acids, ultraviolet absorbers, antioxidants, fluorescent whitening agents, monomers, polymerization initiators, polymerization inhibitors, bleed inhibitors, antiseptics, viscosity stabilizers, defoaming agents, surfactants, antistatic agents, mat agents, curling inhibitors, and water-resistant additives.

Preferable examples of the crosslinking agent for crosslinking the water-soluble resin, especially for crosslinking the polyvinyl alcohol include a boron compound i. Specific examples thereof include borax, boric acid, borates (such as orthoborate, InBO₃, ScBO₃, YBO₃, LaBO₃, Mg₃(BO₃)₂ and CO₃(BO₃)₂), diborates (such as Mg₂B₂O₅ and CO₂B₂O₅), metaborates (such as LiBO₂, Ca(BO₂)₂, NaBO₂, and KBO₂), tetraborates (such as Na₂B₄O₇.10H₂O), pentaborates (such as KB₅O₈.4H₂O and CsB₅O₅) and hexaborates (such as Ca₂B₆O₁₁.7H₂O). Among these, from the viewpoint of rapidness of crosslinking reaction, borax, boric acid, and borates may be preferable, and boric acid may be particularly preferable.

Examples of a crosslinking agent for crosslinking the water-soluble resin include, in addition to the boron compounds, those described below. Examples of the crosslinking agent for crosslinking the water-soluble resin include: aldehyde compounds, such as formaldehyde, glyoxal and gultaraldehyde; ketone compounds, such as diacetyl and cyclopentanedione; active halogen compounds, such as bis(2-chloroethylurea)-2-hydroxy-4,6-dichloro-1,3,5-triazine and sodium salts of 2,4-dichloro-6-s-triazine; active vinyl compounds, such as divinylsulfonic acid, 1,3-bis(vinylsulfonyl)-2-propanol, N,N′-ethylenebis(vinylsulfonylacetamide) and 1,3,5-triacryloyl-hexahydro-s-triazine; N-methylol compounds, such as dimethylolurea and methyloldimethylhydantoin; melamine resins, such as methylolmelamine and alkylated methylolmelamine; epoxy resins; isocyanate compounds, such as 1,6-hexamethylene diisocyanate; the aziridine compounds described in U.S. Pat. Nos. 3,017,280 and 2,983,611; the carboxylmide compounds described in U.S. Pat. No. 3,100,704; epoxy compounds, such as glycerol triglycidyl ether; ethyleneimino compounds, such as 1,6-hexamethylene-N,N′-bisethyleneurea; halogenated carboxyaldehyde compounds, such as mucochloric acid and mucophenoxychloric acid; dioxane compounds, such as 2,3-dihydroxydioxane; metal-containing compounds, such as titanium lactate, aluminum sulfate, chrome alum, potassium alum, zirconyl acetate, and chromium acetate; polyamine compounds, such as tetraethylenepentamine; hydrazide compounds, such as adipic acid dihydrazide; low-molecular compounds each having at least two oxazoline groups; and polymers each having at least two oxazoline groups.

The crosslinking agent may be used singly, or two or more thereof may be used in combination.

The amount of the crosslinking agent to be used is preferably from 1% by mass to 50% by mass, and more preferably from 5% by mass to 40% by mass, with respect to the content of the water-soluble resin in the image recording layer.

The image recording layer according to the present invention may contain an acid. When adding an acid, the surface pH of the image recording layer is adjusted to be in a range of from 3 to 8, and preferably from 5 to 7.5. When adjusting the surface pH as described above, resistance to yellowing of the white background area is improved, which is preferable. Measurement of the surface pH is performed according to the “A method” (coating method) in the surface pH measurement methods defined by Japan Technical Association of the Pulp and Paper Industry (J. TAPP I). For example, the measurement may be performed using a pH indicator set for surface of paper, “TYPE MPC” (trade name, manufactured by Kyoritsu Chemical-Check Lab., Corporation), which corresponds to the above A method.

Specific examples of the acid include formic acid, acetic acid, glycolic acid, oxalic acid, propionic acid, malonic acid, succinic acid, adipic acid, maleic acid, malic acid, tartaric acid, citric acid, benzoic acid, phthalic acid, isophthalic acid, glutaric acid, gluconic acid, lactic acid, aspartic acid, glutamic acid, salicylic acid, metal salts of salicylic acid (salt of Zn, Al, Ca, Mg, or the like), methanesulfonic acid, itaconic acid, benzenesulfonic acid, toluenesulfonic acid, trifluoromethanesulfonic acid, styrenesulfonic acid, trifluoroacetic acid, barbituric acid, acrylic acid, methacrylic acid, cinnamic acid, 4-hydroxybenzoic acid, aminobenzoic acid, naphthalenedisulfonic acid, hydroxybenzenesulfonic acid, toluenesulfinic acid, benzenesulfinic acid, sulfanilic acid, sulfamic acid, α-resorcylic acid, β-resorcylic acid, γ-resorcylic acid, gallic acid, fluoroglycine, sulfosalicylic acid, ascorbic acid, erythorbic acid, bisphenolic acid, hydrochloric acid, nitric acid, sulfuric acid, phosphoric acid, polyphosphoric acid, boric acid, and boronic acid. The addition amount of the acid may be determined such that the surface pH of the image recording layer is adjusted to be from 3 to 8.

The acid may be used in the form of a metal salt (for example, a salt of sodium, potassium, calcium, cesium, zinc, copper, iron, aluminum, zirconium, lanthanum, yttrium, magnesium, strontium, or cerium) or in the form of an amine salt (for example, ammonia, triethylamine, tributylamine, piperazine, 2-methylpiperazine, or polyallylamine).

The image recording layer in the present invention preferably contains a storability improving agent such as an ultraviolet absorber, an antioxidant, or a bleed inhibitor. Examples of the ultraviolet absorber, antioxidant, and bleed inhibitor include an alkylated phenol compound (examples of which include a hindered phenol compound), an alkylthiomethylphenol compound, a hydroquinone compound, an alkylated hydroquinone compound, a tocopherol compound, a thiodiphenyl ether compound, a compound having two or more thioether bonds, a bisphenol compound, an O-benzyl compound, an N-benzyl compound, an S-benzyl compound, a hydroxybenzyl compound, a triazine compound, a phosphonate compound, an acylaminophenol compound, an ester compound, an amide compound, ascorbic acid, an amine antioxidant, a 2-(2-hydroxyphenyl)benzotriazole compound, a 2-hydroxybenzophenone compound, an acrylate, a water-soluble metal salt, a hydrophobic metal salt, an organometallic compound, a metal complex, a hindered amine compound (examples of which include a TEMPO compound), a 2-(2-hydroxyphenyl)-1,3,5-triazine compound, a metal deactivator, a phosphite compound, a phosphonite compound, a hydroxyamine compound, a nitroso compound, a peroxide scavenger, a polyamide stabilizer, a polyether compound, a basic auxiliary stabilizer, a nucleating agent, a benzofuranone compound, an indolinone compound, a phosphine compound, a polyamine compound, a thiourea compound, a urea compound, a hydrazide compound, an amidine compound, a sugar compound, a hydroxybenzoic acid compound, a dihydroxybenzoic acid compound, or a trihydroxybenzoic acid compound.

Among them, an alkylated phenol compound, a compound having two or more thioether bonds, a bisphenol compound, ascorbic acid, an amine antioxidant, a water-soluble metal salt, a hydrophobic metal salt, an organometallic compound, a metal complex, a hindered amine compound, a hydroxyamine compound, a polyamine compound, a thiourea compound, a hydrazide compound, a hydroxybenzoic acid compound, a dihydroxybenzoic acid compound, and a trihydroxybenzoic acid compound may be preferable.

The additional components described above may be added to the image recording layer forming liquid. An additional component may be used singly, or two or more thereof may be used in combination. The additional components may be used in the form of an aqueous solution, a dispersion, a polymer dispersion, an emulsion, or oil droplets, or may be encapsulated in microcapsules. In the image recording layer the content of the additional components may be preferably from 0.01 g/m² to 10 g/m².

When fumed silica is used as the inorganic fine particles, the silica surface may be processed with a silane coupling agent for the purpose of improving dispersibility of the fumed silica. The silane coupling agent may be preferably selected from those having, in addition to a moiety that performs coupling, an organic functional group. Examples of such organic functional groups include a vinyl group, an amino group (a primary to tertiary amino group or a quaternary ammonium salt), an epoxy group, a mercapto group, a chloro group, an alkyl group, a phenyl group, and an ester group.

The image recording layer may preferably contain an organic solvent having a high boiling temperature for suppressing curling of the image recording layer. The organic solvent having a high boiling temperature is an organic compound having a boiling temperature of 150° C. or higher under ambient pressure, and may be a water-soluble compound or a hydrophobic compound. Such organic solvent having a high boiling temperature may be liquid or solid at room temperature, and may be a low molecular-weight compound or a high molecular-weight compound. Specific examples of the organic solvent having a high boiling temperature include aromatic carboxylic acid esters (for example, dibutyl phthalate, diphenyl phthalate, and phenyl benzoate), aliphatic carboxylic acid esters (for example, dioctyl adipate, dibutyl sebacate, methyl stearate, dibutyl maleate, dibutyl fumarate, and acetylcitric acid triethyl ester), phosphoric esters (for example, trioctyl phosphate and tricresyl phosphate), epoxy compounds (for example, epoxidated soybean oil and epoxidated fatty acid methyl ester), alcohols (for example, stearyl alcohol, ethylene glycol, propylene glycol, diethylene glycol, triethylene glycol, glycerin, diethylene glycol monobutyl ether, triethylene glycol monobutyl ether, glycerin monomethyl ether, 1,2,3-butanetriol, 1,2,4-butanetriol, 1,2,4-pentanetriol, 1,2,6-hexanetriol, 1,2-hexanediol, thiodiglycol, triethanolamine, and polyethylene glycol), vegetable oils (for example, soy bean oil and sunflower oil), and higher aliphatic carboxylic acids (for example, linoleic acid and oleic acid). Among them, diethylene glycol monobutyl ether, triethylene glycol monobutyl ether, and 1,2-hexanediol may be particularly preferable from the viewpoints of improving ink absorption speed and suppressing a decrease in image density.

The image recording layer may contain a polymer fine particle dispersion. The polymer fine particle dispersion may be used for improving film physical properties such as stabilization of size, suppression of curling, suppression of adhesion, and suppression of film-cracking. Description of the polymer fine particle dispersions is found in JP-A Nos. 62-245258, 62-1316648, and 62-110066. When a dispersion of fine particles of a polymer having a low glass transition temperature (40° C. or lower) is contained in the image recording layer, cracking and curling of the layer may be suppressed.

Additional Processes

The method of producing the recording medium includes forming an image recording layer after the cooling-separation treatment, and may further include other additional processes as necessary. For example, the method of producing the recording medium may further include calendering, which is performed after the formation of the image recording layer, and in which the mage recording layer is calendered by, for example, passing the support having the image recording layer through a nip between rolls under heat and pressure using a super calender, a gloss calender, or the like, whereby surface smoothness, glossiness, transparency, and film strength can be improved. The calendering may sometimes decrease porosity of the image recording layer (which results in decrease in ink absorbency). Therefore, the calender treatment may be performed under conditions in which the porosity of the image recording layer is not largely decreased.

The temperature of a roll used when the calender treatment is performed is preferably from 30° C. to 150° C., and more preferably from 40° C. to 100° C. The linear pressure applied between the rolls in the calender treatment is preferably from 50 kg/cm to 400 kg/cm (from 49 kN/m to 392 kN/m), and more preferably from 100 kg/cm to 200 kg/cm (from 98 kN/m to 196 kN/m).

Although explanations regarding the recording medium are herein given to mainly by way of a recording medium for inkjet recording (inkjet recording medium), media other than inkjet recording media such as those described below may also be similarly produced, and improvement in surface gloss and image clarity and reduction in surface defects can be achieved.

Image Receiving Material for Electrophotography

In embodiments, the recording medium may be an image receiving material for electrophotography. The image receiving material for electrophotography includes the support and, as an image recording layer, at least one toner image receiving layer disposed on at least one surface of the support. The image receiving material for electrophotography may further include one or more other layers, which may be appropriately selected as necessary. Examples of the other layers include a surface protective layer, an intermediate layer, an undercoat layer, a cushioning layer, a charge adjusting layer (antistatic layer), a reflection layer, a color-tint adjusting layer, a storability-improving layer, an adhesion-suppressing layer, an anti-curling layer, or a smoothing layer. These layers may each independently have a single-layer structure or a multilayer structure.

Silver-Salt Photographic Photosensitive Material

In embodiments, the recording medium may be a silver-salt photographic photosensitive material. The silver-salt photographic photosensitive material may have, for example, a configuration in which photosensitive layers (recording layers), which form Y, M, and C (yellow, magenta, and cyan) colors, are provided as an image recording layer on a support. The silver-salt photographic photosensitive material may be a material for use in a silver halide photography in which color development, bleach fixation, washing with water, and drying are conducted, after printing exposure, by sequentially immersing the material in plural processing tanks so as to sequentially pass the material through the plural processing tanks and so as to obtain an image.

Thermal Transfer Image-Receiving Material

In embodiments, the recording medium may be a thermal transfer-image-receiving material. Examples of the thermal transfer-image-receiving material include a material which has a configuration including an image receiving layer as an image recording layer provided on a support, and which is used for a system in which a thermal transfer material including at least a thermally-meltable ink layer provided on a support is heated using a thermal head so as to melt-transfer an ink from the thermally-meltable ink layer.

Material for Thermosensitive Color-Formation Recording

In embodiments, the recording medium may be a material for thermosensitive color-formation recording. Examples of the material for thermosensitive color-formation recording include a material which has a configuration including at least a thermal color-forming layer as an image recording layer provided on a support, and which is used for a thermo-autochrome system (TA system) whereby an image is formed by thermal color formation achieved by repetition of heating with a thermal head and fixation with ultraviolet rays or the like.

Sublimation Transfer Image-Receiving Material

In embodiments, the recording medium may be a sublimation transfer image-receiving material. Examples of the sublimation transfer image-receiving material include a material which has a configuration including at least an image receiving layer as the image recording layer provided on a support, and which is used for a sublimation transfer system involving heating of a sublimation transfer material including, on a support, at least an ink layer containing a thermal diffusive dye (sublimating dye) using a thermal head so as to transfer the thermal diffusive dye from the ink layer.

In the above-described inkjet recording medium, image receiving material for electrophotography, material for thermosensitive color-formation recording, sublimation transfer image-receiving material, thermal transfer image-receiving material, and silver-salt photographic photosensitive material, at least an image recording layer appropriate to each material (an ink receiving layer, a toner image receiving layer, a thermal color-forming layer, an image receiving layer, or a photosensitive layer) is provided on the support.

### EXAMPLES

In the following, the invention is described in further detail with reference to examples. However, the examples are not be construed as limiting the invention. The terms “part” and “%” are based on mass, unless indicated otherwise.

Preparation of Base Paper

50 parts of LBKP obtained from acacia and 50 parts of LBKP obtained from aspen were respectively beaten using a double disc refiner to give a Canadian freeness of 300 mL, and thus a pulp slurry was prepared.

Subsequently, to the pulp slurry obtained as described above, 1.3% of cationic starch (trade name: CAT 0304L, manufactured by Nippon NSC, Ltd.), 0.15% of anionic polyacylamide (trade name: POLYACRON ST-13, manufactured by Seiko PMC Corporation), 0.29% of an alkyl ketene dimer (trade name: SIZEPINE K, manufactured by Arakawa Chemical Industries, Ltd.), 0.29% of epoxidated behenic acid amide, and 0.32% of polyamide-polyamine-epichlorohydrin (trade name: ARAFIX 100, manufactured by Arakawa Chemical Industries, Ltd.) were added, and thereafter 0.12% of a defoaming agent was added thereto. The percentages above are percentages relative to the pulp.

The pulp slurry prepared as described above was used for paper making using a Fourdrinier paper machine. The felt face of the web was pressed against a drum dry cylinder with a dryer canvas interposed therebetween at a tensile strength of the dryer canvas set at 1.6 kg/cm, thereby drying the web. Then, polyvinyl alcohol (trade name: KL-118, manufactured by Kuraray Co., Ltd.) was coated on both sides of the base paper in an amount of 1 g/m² by size press, and then dried and calendered. The base paper was formed to have a basis weight of 157 g/m², and thus a base paper having a thickness of 157 μm was obtained.

Preparation of Support

The wire face side of the obtained base paper was subjected to corona discharge treatment. Thereafter, polyethylene prepared by blending high density polyethylene and low density polyethylene at a mass ratio (high density polyethylene/low density polyethylene) of 8/2 was coated on the wire face in a coating amount of 13 g/m² by melt extrusion at a temperature of 320° C. using a melt extruder, whereby a polyethylene resin layer having a matte surface was formed. The thickness of the polyethylene resin layer was 13 μm.

Hereinafter, the surface to which the polyethylene resin layer was provided by the above process is referred to as a “backside face”, and the other surface is referred to as a “front face”.

The polyethylene resin layer on the backside face was subjected to a corona discharge treatment, and thereafter, a backside coating layer forming liquid prepared as below was coated in a dry mass of 0.2 g/m². As a result, a pigment-containing layer (which is referred to as a “back coat layer” hereinafter) was formed.

Preparation of Backside Coating Layer Forming Liquid

14 parts of the following component (A), 8 parts of the following component (B), 6 parts of colloidal silica, and 20 parts of methanol were mixed. Further, water was added thereto to adjust the total amount to 100 parts.

Component (A)

In the presence of a reactive emulsifying agent (trade name: ADEKA REASOAP SE-10N, manufactured by Asahi Denka Kogyo Co., Ltd.), 62 parts of styrene, 5 parts of glycidyl methacrylate, 3 parts of acrylic acid, and 30 parts of 2-ethylhexyl acrylate were subjected to emulsion polymerization to obtain a water dispersion of a styrene-acrylic ester copolymer (component (A)) having a solid content of 20% by mass.

Component (B)

A styrene-isoprene AB block copolymer (styrene/isoprene=80/20 (by mole ratio), weight average molecular weight: 7500) was sulfonated to have a sulfonic acid content of 2 mmol/g, and was neutralized using sodium hydroxide to obtain a water-soluble polymer sodium salt (component (B)).

Subsequently, the front face was subjected to a corona discharge treatment, and then, polyethylene having a density of 0.93 g/cm³ which includes 10% by mass of titanium oxide was coated thereon in an amount of 18 g/m² by melt extrusion at a temperature of 320° C. using a melt extruder, whereby a polyethylene resin layer was formed. The thickness of the polyethylene resin layer was 18 μm.

A liquid which was prepared by adding 0.8 parts of a 10% solution of EMULGEN 109P (trade name, manufactured by Kao Corporation) to 100 parts of a 22.5% aqueous dispersion of polyester urethane latex HYDRAN AP-40F (trade name, manufactured by Dainippon. Ink and Chemicals Inc., Tg: 49° C., minimum film-formation temperature (MFT): 29° C.) and sufficiently mixed by stirring was applied on the polyethylene resin layer provided on the front face so that the application amount thereof become 5.0 g/m², whereby an undercoat layer was formed.

A support which has the first-described polyethylene resin layer and the undercoat layer provided on its front face and the second-described polyethylene resin layer and the pigment-containing layer provided on its backside face was thus obtained.

Cooling-Separation Treatment

The support was processed using a cooling-separation-belt-fixing-smoother apparatus (an endless press) shown in FIG. 1, in such a manner that the front face contacted with the endless belt 2. In this process, the heating temperature was 70° C., and the cooling temperature was 40° C. Further, the conveyance speed of the belt at the time of applying heat and pressure and at the time of cooling was 20 mm/sec.

Here, the “heating temperature” means a temperature of a heating roll 3, and is measured using a non-contact thermometer. Further, the “cooling temperature” means a temperature of a portion of the endless belt 2 that contacts with the cooling device 7 described below, and is measured using a non-contact thermometer.

In the cooling-separation-belt-fixing-smoother apparatus (endless press) shown in FIG. 1, a processing section 1 is equipped with an endless belt 2, a heating roll 3, a pressurization roll 4, tension rolls 5, a cleaning roll 6, a cooling device 7, and conveyance rolls 8.

The heating roll 3 and a pair of tension rolls 5 are disposed at the inner side of the endless belt 2. The pair of tension rolls 5 is disposed at a distance from the heating roll 3. The endless belt 2 is rotatably stretched by the heating roll 3 and the tension rolls 5. The pressurization roll 4 is in contact with the outer circumferential surface of the endless belt 2 and, specifically, is disposed to face the heating roll 3 with the endless belt 2 therebetween. Pressure is applied to a portion of the endless belt 2 located between the pressurization roll 4 and the heating roll 3, by the pressurization roll 4 and the heating roll 3, thereby forming a nip portion. The cooling device 7 is disposed at the inner side of the endless belt 2. The cooling device 7 is positioned between the heating roll 3, which is positioned upstream (upstream in the conveyance direction of the endless belt 2), and the tension rolls 5, which are positioned downstream (downstream in the conveyance direction of the endless belt 2). The conveyance rolls 8, two in number, are disposed to face the cooling device 7 with the endless belt 2 therebetween. Here, the distance between the two conveyance rolls 8 is substantially equal to the distance between the nip portion and one of the conveyance rolls 8 close to the nip portion, and the distance between the other one of the conveyance rolls 8 and one of the tension rolls 5 closer thereto. The cleaning roll 6 is disposed at a side of the heating roll 3 opposite to the side at which the pressurization roll 4 is provided, and a portion of the endless belt 2 is present between the cleaning roll 6 and the heating roll 3. A pressure is applied to a portion of the endless belt 2 located between the cleaning roll 6 and the heating roll 3, by the cleaning roll 6 and the heating roll 3. The heating roll 3, the pressurization roll 4, the tension rolls 5, the cleaning roll 6, and the conveyance rolls 8 rotate synchronously, thereby allowing the endless belt 2 to rotate.

A support processed in the processing section 1 is conveyed to the cooling device 7 after the temperature of the support has reached the same temperature as the temperature of the heating roll 3. Further, the support is cooled down to the same temperature as the temperature of the endless belt 2 cooled by the cooling device 7.

In the processing section 1, the surface roughness (arithmetic average roughness (Ra)) of the endless belt 2 was 0.8 μm, and the pressure between rolls (nip pressure) was 7.5 kgf/cm².

A belt prepared in the following manner was used as the belt member.

A primer for a silicone rubber, DY39-115 (trade name, manufactured by Dow Corning Toray Silicone Co., Ltd.), was coated on a base layer made of polyimide, and drying by air was performed for 30 minutes. After drying, the base layer was immersed in a coating liquid formed by 100 parts by mass of a silicone rubber precursor DY35-796AB (trade name, manufactured by Dow Corning Toray Silicone Co., Ltd., Japan) and 30 parts by mass of n-hexane, thereby forming a coating film. Then, the coating film was subjected to primary vulcanization at 120° C. for 10 minutes, whereby a silicone rubber layer having a thickness of 40 μm was formed.

On the silicone rubber layer, a coating liquid prepared from 100 parts by mass of a fluorocarbon siloxane rubber precursor SIFEL 610 (trade name, manufactured by Shin-Etsu Chemical Co., Ltd.) and 20 parts by mass of a mixed solvent of fluorine-containing solvents (m-xylene hexafluoride, perfluoroalkane, and perfluoro(2-butyltetrahydrofuran)) was coated by immersion to form a coating film. Then, the coating film was subjected to primary vulcanization at 120° C. for 10 minutes, and to secondary vulcanization at 180° C. for 4 hours. In this way, an endless belt having a 20 μm-thickness fluorocarbon siloxane rubber layer was prepared.

Preparation of Inkjet Recording Medium

The front face of the support was subjected to corona discharge treatment. Thereafter, the image recording layer forming liquid described below and the PAC (polyaluminum chloride) liquid described below were in-line blended, and the blended liquid was coated on the front surface using an extrusion die coater such that the coating amount of the image recording layer forming liquid was 183 g/m² and the PAC liquid was 11.4 g/m². Thereafter, the resulting coating layer was dried at 80° C. using a hot air dryer (at an air flow rate of from 3 msec to 8 msec) until the solid content of the coated layer become 20%. This coating layer showed constant-rate drying during this drying process. Before the coating layer starts falling-rate drying, the support was dipped in a basic solution having the following formulation (pH: 7.8) so that the adhering amount of the base solution becomes 13 g/m². Thereafter, the resulting coating layer was dried at 65° C. for 10 minutes (curing). An inkjet recording sheet, which is an inkjet recording medium having an ink receiving layer of a drying thickness of 32 μm, was thus prepared.

Formulation of Basic Solution

| | |
|---|---|
| (1) Boric acid | 0.65 parts |
| (2) Ammonium carbonate (first grade) (manufactured by | 3.5 parts |
| Kanto Chemicals Co., Inc) | |
| (3) Ion-exchange water | 63.6 parts |
| (4) Polyoxyethylene lauryl ether (surfactant, trade name: | 30.0 parts |
| EMULGEN 109P, manufactured by Kao Corporation) | |

Preparation of Image Recording Layer Forming Liquid

According to the “Formulation of silica dispersion liquid” described below, silica fine particles were mixed with a liquid prepared by mixing dimethyldiallylammonium chloride polymer (trade name: SHALLOL DC-902P) with ion-exchange water. Then ZIRCOSOL ZA-30 (trade name) was further added to the resulting mixture. The resulting slurry was further subjected to dispersion using ULTIMIZER (trade name), manufactured by Sugino Machine Limited, under a pressure of 170 MPa, whereby a silica dispersion liquid including silica fine particles having a median diameter (an average particle diameter) of 120 nm was prepared.

According to the “Formulation of image recording layer forming liquid” described below, ion-exchange water, a 7.5% boric acid solution, SC-505 (trade name), a polyvinyl alcohol solution, and SUPERFLEX 650-5 (trade name) were sequentially added to the above silica dispersion liquid, followed by mixing, whereby an image recording layer forming liquid was prepared.

Formulation of Silica Dispersion Liquid

| | |
|---|---|
| (1) Vapor-phase silica fine particles (AEROSIL | 15.0 parts |
| (registered trademark) 300SF75, manufactured by | |
| Nippon Aerosil Co., Ltd.) | |
| (2) Ion-exchange water | 82.9 parts |
| (3) SHALLOL DC-902P (51.5% solution) (trade name, | 1.31 parts |
| dispersant; manufactured by Dai-ichi Kogyo | |
| Seiyaku Co., Ltd.) | |
| (4) Zirconyl acetate (ZIRCOSOL ZA-30 (trade name), | 0.81 parts |
| manufactured by Daiichi Kigenso Kagaku Kogyo Co., Ltd., | |
| 50% solution) | |

Formulation of Image Recording Layer Forming Liquid

| | |
|---|---|
| (1) Silica dispersion liquid | 59.5 parts |
| (2) Ion-exchange water | 7.8 parts |
| (3) 7.5% boric acid solution (crosslinking agent) | 4.4 parts |
| (4) Dimethylamine/epichlorohydrin/polyalkylene polyamine | 0.1 parts |
| polycondensate (50% solution), (trade name: SC-505, | |
| manufactured by HYMO Co., Ltd.) | |
| (5) Polyvinyl alcohol solution described below | 26.0 parts |
| (6) Cation-modified polyurethane | 2.2 parts |
| (trade name, SUPERFLEX 650-5, manufactured by | |
| Dai-Ichi Kogyo Seiyaku Co., Ltd. (25% solution)) | |

Formulation of Polyvinyl Alcohol Solution

| | |
|---|---|
| (1) Polyvinyl alcohol (PVA) | 6.96 parts |
| (trade name: JM-33, manufactured by JAPAN VAM & | |
| POVAL Co., Ltd., having a saponification degree of | |
| 94.3 mol % and a polymerization degree of 3300) | |
| (2) Polyoxyethylene lauryl ether | 0.23 parts |
| (surfactant; trade name: EMULGEN 109P, manufactured by | |
| Kao Corporation) | |
| (3) Diethylene glycol monobutyl ether | 2.12 parts |
| (trade name: BUTYCENOL 20P, manufactured by Kyowa | |
| Hakko Chemical Co., Ltd.) | |
| (4) Ion-exchange water | 90.69 parts |

Formulation of PAC Liquid

| | |
|---|---|
| (1) Polyaluminum chloride aqueous solution having a basicity | 20 parts |
| of 83% (trade name: ALFINE 83, manufactured by | |
| Taimei Chemical Co., Ltd.) | |
| (2) Ion-exchange water | 80 parts |

Evaluations

Measurement and evaluation were performed with respect to the following items as follows. Results are shown in the following Table 1.

(1) Evaluation of Image Clarity

Based on the method of image clarity test defined in JIS H8686-2: 1999 (described above), the image clarity of a front surface of the recording medium was measured using an image clarity meter, ICM-1 (trade name, manufactured by Suga Test Instruments Co., Ltd.) under the following measurement and analysis conditions.

Measurement conditions of Image clarity:
Measurement method: reflection
Measurement angle: 60°
Optical comb: 2.0 mm

Evaluation criteria of Image clarity:
A: Image clarity is 80% or higher.
B: Image clarity is 70% or higher but lower than 80%.
C: Image clarity is 30% or higher but lower than 70%.
D: Image clarity is lower than 30%.

(2) Evaluation of Surface Defects

The surface condition of a surface of the recording medium that has an image recording layer was visually observed, and the number of crack defects in an area of 100 m² was determined.

Evaluation criteria of Surface defects:
A: no crack is observed.
B: the number of cracks is one or two, which is practically acceptable.
C: the number of cracks is from three to ten, which is practically problematic.

(3) Evaluation of Blocking Resistance

The support was cut into a size of 10 centimeters square sheets, and the sheets were left to stand at 23° C. under an atmosphere of 80% RH for one day. Then, five sheets of the support were piled up such that a front face of one sheet and a surface of another sheet at a backside face contacted with each other, and a load of 2 kg/m² was placed thereon. The stacked sheets in this state were stored at 40° C. under an atmosphere of 80% RH for one week. Thereafter, an average level of blocking resistance of the support was evaluated.

On the other hand, the inkjet recording medium was cut into a size of 10 centimeters square sheets, and the sheets were left to stand at 23° C. under an atmosphere of 80% RH for one day. Then, five sheets of the recording medium were piled up such that a surface of one sheet having an image recording layer and a surface of another sheet at a side opposite to the image recording layer side contacted with each other, and a load of 2 kg/m² was placed thereon. The stacked sheets in this state were stored at 40° C. under an atmosphere of 80% R^{H} for one week. Thereafter, an average level of blocking resistance of the inkjet recording medium was evaluated.

Evaluation criteria of Blocking resistance:
A: the sheets are separated with small force.
B: the sheets are not separated with small force.

### Example 2

A recording medium of Example 2 was prepared and evaluated in the substantially similar manner to that of Example 1, except that HYDRAN AP-30F (trade name, manufactured by Dainippon Ink and Chemicals Inc.) was used in place of the HYDRAN AP-40F (described above) in preparation of the support.

### Example 3

A recording medium of Example 3 was prepared and evaluated in the substantially similar manner to that of Example 1, except that HYDRAN AP-60LM (trade name, manufactured by Dainippon. Ink and Chemicals Inc.) was used in place of the HYDRAN AP-40F (described above) in preparation of the support.

### Example 4

A recording medium of Example 4 was prepared and evaluated in the substantially similar manner to that of Example 1, except that AQUABRID 46704 (trade name, manufactured by Daicel Chemical Industries, Ltd.,) was used in place of the HYDRAN AP-40F (described above) in preparation of the support.

### Example 5

A recording medium of Example 5 was prepared and evaluated in the substantially similar manner to that of Example 1, except that AQUABRID 903 (trade name, manufactured by Daicel Chemical Industries, Ltd.,) was used in place of the HYDRAN AP-40F (described above) in preparation of the support.

### Example 6

A recording medium of Example 6 was conducted in the substantially similar manner to that of Example 1, except that the heating temperature in the cooling-separation treatment, which was 70° C. in Example 1, was changed to 50° C.

### Example 7

A recording medium of Example 7 was prepared and evaluated in the substantially similar manner to that of Example 1, except that no back coat layer was provided in preparation of the support.

### Example 8

A recording medium of Example 8 was prepared and evaluated in the substantially similar manner to that of Example 5, except that the heating temperature in the cooling-separation treatment, which was 70° C. in Example 5, was changed to 40° C.

### Example 9

A recording medium of Example 9 was prepared and evaluated in the substantially similar manner to that of Example 1, except that AQUABRID 4790 (trade name, manufactured by Daicel Chemical Industries, Ltd.,) was used in place of the HYDRAN AP-40F (described above) in preparation of the support.

### Example 10

A recording medium of Example 10 was prepared and evaluated in the substantially similar manner to that of Example 1, except that the heating temperature in the cooling-separation treatment, which was 70° C. in Example 1, was changed to 90° C.

### Example 11

A recording medium of Example 11 was prepared and evaluated in the substantially similar manner to that of Example 1, except that the cooling temperature in the cooling-separation treatment, which was 40° C. in Example 1, was changed to 30° C.

### Example 12

A recording medium of Example 12 was prepared and evaluated in the substantially similar manner to that of Example 1, except that the cooling temperature in the cooling-separation treatment, which was 40° C. in Example 1, was changed to 50° C.

### Example 13

A recording medium of Example 13 was prepared and evaluated in the substantially similar manner to that of Example 1, except that the formation of an image recording layer was conducted as described below.

Formation of Image Recording Layer of Example 13

The front face of the support was subjected to corona discharge treatment. Thereafter, the image recording layer forming liquid described below and the PAC (polyaluminum chloride) liquid described below were in-line blended, and the blended liquid was coated on the front surface using an extrusion die coater such that the coating amount of the image recording layer forming liquid was 183 g/m² and the PAC liquid was 11.4 g/m². Thereafter, the resulting coating layer was dried at 5° C. and 30% relative humidity using a cold air dryer (at an air flow rate of from 3 msec to 8 msec) for 5 minutes, and was further dried with a dry air having a temperature of 25° C. and a relative humidity of 25% (at an air flow rate of from 3 msec to 8 msec) for 20 minutes. Thereby, an image recording layer having a dry layer thickness of 30 μm was formed on the support.

### Comparative Example 1

A recording medium of Comparative example 1 was prepared and evaluated in the substantially similar manner to that of Example 1, except that the coating of the latex HYDRAN AP-40F (described above) was omitted in preparation of the support.

### Comparative Example 2

A recording medium of Comparative example 2 was prepared and evaluated in the substantially similar manner to that of Example 1, except that the heating-pressurizing and the cooling in the cooling-separation treatment were omitted in preparation of the support.

### Comparative Example 3

A recording medium of Comparative example 3 was prepared and evaluated in the substantially similar manner to that of Example 1, except that the cooling in the cooling-separation treatment was omitted in preparation of the support.

The results are shown in Tables 1 and 2.

TABLE 1

| | | | | | | | | | | | | Blocking |
|---|---|---|---|---|---|---|---|---|---|---|---|---|
| | Back- | | | | | | | | | | | resistance |
| | side | Undercoat layer | | | | | | Cooling | | | Blocking | of Inkjet |
| | coating | Product | | | | Amount | Heating | temp- | Image | Surface | resistance | recording |
| | layer | name | Kind | Tg | MFT | of latex | temperature | erature | clarity | defects | of Support | medium |
| Example 1 | Colloidal | HYDRAN | Urethane | 49° C. | 29° C. | 5.0 g/m² | 70° C. | 40° C. | A | A | A | A |
| | silica | AP-40F | | | | | | | | | | |
| Example 2 | Colloidal | HYDRAN | Urethane | 61° C. | <0 | 5.0 g/m² | 70° C. | 40° C. | A | A | A | A |
| | silica | AP-30F | | | | | | | | | | |
| Example 3 | Colloidal | HYDRAN | Urethane | −12° C. | <0 | 5.0 g/m² | 70° C. | 40° C. | A | A | B | A |
| | silica | AP-60LM | | | | | | | | | | |
| Example 4 | Colloidal | AQUABRID | Acryl | 60° C. | 40° C. | 5.0 g/m² | 70° C. | 40° C. | A | A | A | A |
| | silica | 46704 | | | | | | | | | | |
| Example 5 | Colloidal | AQUABRID | Acryl | 10° C. | 30° C. | 5.0 g/m² | 70° C. | 40° C. | A | A | A | A |
| | silica | 903 | silicone | | | | | | | | | |
| Example 6 | Colloidal | HYDRAN | Urethane | 49° C. | 29° C. | 5.0 g/m² | 50° C. | 40° C. | A | A | A | A |
| | silica | AP-40F | | | | | | | | | | |
| Example 7 | — | HYDRAN | Urethane | 49° C. | 29° C. | 5.0 g/m² | 70° C. | 40° C. | A | A | A | B |
| | | AP-40F | | | | | | | | | | |
| Example 8 | Colloidal | AQUABRID | Acryl | 10° C. | 30° C. | 5.0 g/m² | 40° C. | 40° C. | B | A | A | A |
| | silica | 903 | silicone | | | | | | | | | |

TABLE 2

| | | | | | | | | | | | | Blocking |
|---|---|---|---|---|---|---|---|---|---|---|---|---|
| | Back- | | | | | | | | | | | resistance |
| | side | Undercoat layer | | | | | | Cooling | | | Blocking | of Inkjet |
| | coating | Product | | | | Amount | Heating | temp- | Image | Surface | resistance | recording |
| | layer | name | Kind | Tg | MFT | of latex | temperature | erature | clarity | defects | of Support | medium |
| Example 9 | Colloidal | AQUABRID | Acryl | 25° C. | 35° C. | 5.0 g/m² | 40° C. | 40° C. | A | A | A | A |
| | silica | 4790 | styrene | | | | | | | | | |
| Example 10 | Colloidal | HYDRAN | Urethane | 49° C. | 29° C. | 5.0 g/m² | 90° C. | 40° C. | B | A | A | A |
| | silica | AP-40F | | | | | | | | | | |
| Example 11 | Colloidal | HYDRAN | Urethane | 49° C. | 29° C. | 5.0 g/m² | 70° C. | 30° C. | A | A | A | A |
| | silica | AP-40F | | | | | | | | | | |
| Example 12 | Colloidal | HYDRAN | Urethane | 49° C. | 29° C. | 5.0 g/m² | 70° C. | 50° C. | B | A | A | A |
| | silica | AP-40F | | | | | | | | | | |
| Example 13 | Colloidal | HYDRAN | Urethane | 49° C. | 29° C. | 5.0 g/m² | 70° C. | 40° C. | A | A | A | A |
| | silica | AP-40F | | | | | | | | | | |
| Comparative | Colloidal | — | — | — | — | — | 70° C. | 40° C. | C | C | A | A |
| example 1 | silica | | | | | | | | | | | |
| Comparative | Colloidal | HYDRAN | Urethane | 49° C. | 29° C. | 5.0 g/m² | — | — | C | B | A | A |
| example 2 | silica | AP-40F | | | | | | | | | | |
| Comparative | Colloidal | HYDRAN | Urethane | 49° C. | 29° C. | 5.0 g/m² | 70° C. | — | C | B | A | A |
| example 3 | silica | AP-40F | | | | | | | | | | |

As is shown in Tables 1 and 2, all of the recording media of Examples were excellent in every evaluation item. In contrast, the recording media of Comparative examples were practically problematic due to inferior image clarity and surface defects.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. A method of producing a recording medium, the method comprising:
providing a support, the support comprising: a resin layer comprising a polyolefin resin and provided on one side or both sides of a base paper; and a latex-containing layer formed by applying at least a latex on the resin layer;
subjecting a latex-containing layer-side surface of the support to a cooling-separation treatment using a cooling-separation belt-fixing smoother apparatus,
the apparatus comprising a heating and pressurizing unit,
the unit comprising a belt member, and
the cooling-separation treatment comprising separating the latex-containing layer-side surface of the support from the belt member; and
forming an image recording layer on the latex-containing layer-side surface of the support which has been subjected to the cooling-separation treatment.

2. The method of producing a recording medium according to claim 1, wherein the cooling-separation treatment comprises:
heating and pressurizing the latex-containing layer-side surface of the support at a temperature of at least 60° C. and less than 100° C.;
cooling the heated and pressurized surface to a temperature of lower than 60° C.; and
separating the cooled surface from the belt member.

3. The method of producing a recording medium according to claim 1, wherein the cooling-separation treatment comprises heating and pressurizing the latex-containing layer-side surface of the support at a temperature of from 60° C. to 90° C.

4. The method of producing a recording medium according to claim 1, wherein the cooling-separation treatment comprises separating the latex-containing layer-side surface of the support after cooling the surface to a temperature of at least 25° C. and less than 60° C.

5. The method of producing a recording medium according to claim 1, wherein the support further comprises a layer containing a pigment on one side of the base paper, and the image recording layer is formed on a surface at a side of the support not having the pigment-containing layer.

6. The method of producing a recording medium according to claim 1, wherein the resin layer containing a polyolefin resin is formed on both sides of the base paper, and a layer containing a pigment is formed on the resin layer on one side or both sides of the base paper.

7. The method of producing a recording medium according to claim 1, wherein the latex comprises at least one selected from the group consisting of urethane latexes, acryl silicone latexes and acryl styrene latexes.

8. The method of producing a recording medium according to claim 1, wherein the latex is applied in an amount of from 1 to 10 g/m² in terms of solid content.

9. The method of producing a recording medium according to claim 1, wherein the image recording layer comprises inorganic fine particles and a water-soluble resin.

10. The method of producing a recording medium according to claim 9, wherein the recording medium is an inkjet recording medium.

11. A recording medium produced by the method of producing a recording medium of claim 9.

12. The recording medium of claim 11, wherein the resin layer containing a polyolefin resin has a thickness of from 10 μm to 18 μm, and a surface roughness SRa of from 0.02 μm to 0.20 μm with a frequency of from 0.2 mm to 0.3 mm.

13. An inkjet recording medium produced by the method of producing a recording medium of claim 10.
